(19) United States
(12) Patent Application Publication
(10) Pub. No.: US 2012/0314675 A1
(43) Pub. Date: Dec. 13, 2012

(54) METHOD FOR MANAGING CARRIER AGGREGATION SETS, AND RELATED DEVICES

(75) Inventor: Dragan Vujcic, Limours (FR)

(73) Assignee: LG ELECTRONICS INC., Seoul (KR)

(21) Appl. No.: 13/580,113

(22) PCT Filed: Feb. 21, 2011
(86) PCT No.: PCT/KR2011/001114

§ 371 Date: Aug. 20, 2012

Related U.S. Application Data
(60) Provisional application No. 61/306,527, filed on Feb. 21, 2010.

(51) Int. Cl. H04W 72/08

(52) U.S. Cl. 370/329

(57) ABSTRACT

The disclosure relates to a method for managing aggregation of component carriers between an e Node B and a user equipment, which comprises providing a first set of configured component carriers and a second set of activated component carriers. The disclosure also relates to the corresponding e Node B and user equipment.

### TECHNICAL FIELD

The present invention relates to carrier aggregation management in a radiocommunication system.

### BACKGROUND ART

Many different types of radiocommunication systems (i.e. networks) exist. GSM, UMTS, LTE and LTE-advanced are non-limiting examples of such radiocommunication systems.

FIG. 1 is a block diagram showing a radiocommunication system. This may be a network structure of a 3rd generation partnership project (3GPP) long term evolution (LTE)/LTE-advanced (LTE-A). An E-UTRAN (Evolved-UMTS Terrestrial Radio Access Network) includes at least one base station (BS) 20 providing a user plane and a control plane towards a user equipment (UE) 10. The UE can be fixed or mobile and can be referred to as another terminology, such as a MS (Mobile Station), a UT (User Terminal), a SS (Subscriber Station), MT (mobile terminal), a wireless device, or the like. The BS 20 may be a fixed station that communicates with the UE 10 and can be referred to as another terminology, such as an e-NB (evolved-NodeB), a BTS (Base Transceiver System), an access point, or the like. There are one or more cells within the coverage of the BS 20. Interfaces for transmitting user data or control data can be used between BSs 20 (in the present document, the term “data” is used as a synonymous for “traffic” and does not imply any limitation as to the nature of such data, which can refer e.g. to user traffic or control traffic i.e. signaling). The BSs 20 are interconnected with each other by means of an X2 interface. The BSs 20 are also connected by means of the S1 interface to the EPC (Evolved Packet Core). They may interface to the aGW (E-UTRAN Access Gateway) via the S1. In the example shown in FIG. 1, the BSs 20 are more specifically connected to the MME (Mobility Management Entity) by means of the S1-MME and to the Serving Gateway (S-GW) by means of the S1-U. The S1 interface supports a many-to-many relation between MME/S-GW 30 and the BS 20.

Hereinafter, downlink means communication from the BS 20 to the UE 10, and uplink means communication from the UE 10 to the BS 20. In downlink, a transmitter may be a part of the BS 20 and a receiver may be a part of the UE 10. In uplink, a transmitter may be a part of the UE 20 and a receiver may be a part of the BS 20.

FIG. 2 gives an overview of the E-UTRAN architecture where:
eNB, aGW Control Plane and aGW User Plane boxes depict the logical nodes;
The boxes within the eNB box from RRC to Inter Cell RRM as well as the boxes SAE Bearer Control and MM Entity within the aGW Control Plane box depict the functional entities of the control plane; and
The boxes within the eNB box from PHY to RLC depict the functional entities of the user plane.

Functions agreed to be hosted by the eNB are: Selection of aGW at attachment; Routing towards aGW at RRC activation; Scheduling and transmission of paging messages; Scheduling and transmission of BCCH information; Dynamic allocation of resources to UEs in both uplink and downlink; The configuration and provision of eNB measurements; Radio Bearer Control; Radio Admission Control; Connection Mobility Control in LTE ACTIVE state.

Functions agreed to be hosted by the aGW are: Paging origination; LTE_IDLE state management; Ciphering of the user plane; PDCP; SAE Bearer Control; Ciphering and integrity protection of NAS signaling.

FIG. 3 shows the user-plane protocol stack for E-UTRAN.

RLC (Radio Link Control) and MAC (Medium Access Control) sublayers (terminated in eNB on the network side) perform the functions such as Scheduling, ARQ (automatic repeat request) and HARQ (hybrid automatic repeat request).

PDCP (Packet Data Convergence Protocol) sublayer (terminated in aGW on the network side) performs for the user plane functions such as Header Compression, Integrity Protection, Ciphering.

FIG. 4 shows the control-plane protocol stack for E-UTRAN. The following working assumptions apply.

RLC and MAC sublayers (terminated in eNB on the network side) perform the same functions as for the user plane;

RRC (Radio Resource Control) (terminated in eNB on the network side) performs the functions such as: Broadcast; Paging; RRC connection management; RB control; Mobility functions; UE measurement reporting and control.

PDCP sublayer (terminated in aGW on the network side) performs for the control plane the functions such as: Integrity Protection; Ciphering.

NAS (terminated in aGW on the network side) performs among other things: SAE bearer management; Authentication; Idle mode mobility handling; Paging origination in LTE_IDLE; Security control for the signaling between aGW and UE, and for the user plane.

RRC uses the following states:

1. RRC IDLE:

UE specific DRX configured by NAS; Broadcast of system information; Paging; Cell re-selection mobility; The UE shall have been allocated an id which uniquely identifies the UE in a tracking area; No RRC context stored in the eNB.

2. RRC CONNECTED:

UE has an E-UTRAN-RRC connection; UE has context in E-UTRAN; E-UTRAN knows the cell which the UE belongs to; Network can transmit and/or receive data to/from UE; Network controlled mobility (handover); Neighbour cell measurements; At RLC/MAC level: UE can transmit and/or receive data to/from network; UE also reports channel quality information and feedback information to eNB.

The network signals UE specific paging DRX (Discontinuous Reception) cycle. In RRC Idle mode, UE monitors a paging at a specific paging occasion of every UE specific paging DRX cycle. The paging occasion is a time interval where a paging is transmitted. UE has its own paging occasion. A paging message is transmitted over all cells belonging to the same tracking area. If UE moves from a tracking area to another tracking area, UE will send a tracking area update message to the network to update its location.

A physical channel transfers signaling and data between UE L1 and eNB L1. As shown in FIG. 5, the physical channel transfers them with a radio resource which consists of one or more sub-carriers in frequency and one more symbols in time. 6 or 7 symbols constitute one sub-frame which is 0.5 ms in length. The particular symbol(s) of the sub-frame, e.g. the first symbol of the sub-frame, can be used for the PDCCH (Physical Downlink Control Channel). PDCCH channel carries L1 signaling.

A transport channel transfers signaling and data between L1 and MAC layers. A physical channel is mapped to a transport channel.

Downlink transport channel types are:

1. Broadcast Channel (BCH) used for transmitting system information

2. Downlink Shared Channel (DL-SCH) characterised by: support for HARQ; support for dynamic link adaptation by varying the modulation, coding and transmit power; possibility to be broadcast in the entire cell; possibility to use beamforming; support for both dynamic and semi-static resource allocation

3. Paging Channel (PCH) used for paging a UE

4. Multicast Channel (MCH) used for multicast or broadcast service transmission.

Uplink transport channel types are:

1. Uplink Shared Channel (UL-SCH) characterised by: possibility to use beamforming; (likely no impact on specifications); support for dynamic link adaptation by varying the transmit power and potentially modulation and coding; support for HARQ

2. Random Access Channel(s) (RACH) used normally for initial access to a cell.

The MAC sublayer provides data transfer services on logical channels. A set of logical channel types is defined for different kinds of data transfer services as offered by MAC. Each logical channel type is defined by what type of information is transferred.

A general classification of logical channels is into two groups:
Control Channels (for the transfer of control plane data);
Traffic Channels (for the transfer of user plane data).

Control channels are used for transfer of control plane data only. The control channels offered by MAC are:
Broadcast Control Channel (BCCH)

A downlink channel for broadcasting system control information
Paging Control Channel (PCCH)

A downlink channel that transfers paging information. This channel is used when the network does not know the location cell of the UE.
Common Control Channel (CCCH)

this channel is used by the UEs having no RRC connection with the network.
Multicast Control Channel (MCCH)

A point-to-multipoint downlink channel used for transmitting MBMS control data from the network to the UE.
Dedicated Control Channel (DCCH)

A point-to-point bi-directional channel that transmits dedicated control data between a UE and the network. Used by UEs having an RRC connection.

Traffic channels are used for the transfer of user plane data only. The traffic channels offered by MAC are:
Dedicated Traffic Channel (DTCH)

A Dedicated Traffic Channel (DTCH) is a point-to-point channel, dedicated to one

UE, for the transfer of user data. A DTCH can exist in both uplink and downlink.
Multicast Traffic Channel (MTCH)

A point-to-multipoint downlink channel for transmitting traffic data from the network to the UE.

In Uplink, the following connections between logical channels and transport channels exist:
DCCH can be mapped to UL-SCH;
DTCH can be mapped to UL-SCH.

In Downlink, the following connections between logical channels and transport channels exist:
BCCH can be mapped to BCH;
PCCH can be mapped to PCH;
DCCH can be mapped to DL-SCH;
DTCH can be mapped to DL-SCH;
MCCH can be mapped to MCH;
MTCH can be mapped to MCH;

Conventionally, only one carrier (e.g. a frequency band) is used at a time with respect to a given UE for transporting data, such as useful data and/or control data.

But for supporting wider transmission bandwidths, it would be better to use carrier aggregation, that is simultaneous support of multiple carriers. Carrier aggregation would thus involve transporting data, such as useful data and/or control data, over a plurality of carriers with respect to a given UE. It would thus enhance the conventional carrier usage and be adapted to the multiple access type of the considered radio communication system.

As far as LTE is concerned, carrier aggregation has been introduced in a recent version thereof, so-called LTE-Advanced, which extends LTE Release 8 (LTE Rel-8). Some aspects of carrier aggregation are disclosed for example in 3GPP TR 36.814 V0.4.1, 3rd Generation Partnership Project; Technical Specification Group Radio Access Network; Further Advancements for E-UTRA Physical Layer Aspects (Release 9) released in February 2009 (see section 5 in particular), as well as in subsequent versions thereof. Other standard documents, which are well known by one skilled in the art, relate to other aspects of carrier aggregation.

Thus LTE-Advanced allows having two or more carriers, so-called component carriers (CCs), aggregated in order to support wider transmission bandwidths e.g. up to 100 MHz and for spectrum aggregation.

In contrast with an LTE Rel-8 terminal, an LTE-Advanced terminal with reception and/or transmission capabilities for carrier aggregation can simultaneously receive and/or transmit on multiple component carriers.

According to a non-limiting example, a carrier may be defined by a bandwidth and a center frequency. If five carriers are assigned as granularity of carrier unit having a 5 MHz bandwidth, carrier aggregation may lead to a bandwidth of a maximum of 20 MHz.

Contiguous spectrum aggregation and/or non-contiguous spectrum aggregation may take place. The contiguous spectrum aggregation uses contiguous carriers and the non-contiguous spectrum aggregation uses non-contiguous carriers. The number of aggregated carriers may be different in uplink and downlink. When the number of downlink carriers and that of uplink carriers are equal, it is called a symmetric aggregation, and when the numbers are different, it is called an asymmetric aggregation.

The size (i.e., the bandwidth) of multiple carriers may vary. For example, when five carriers are used to configure a 70 MHz band, they may be configured as 5 MHz carrier (carrier #0)+20 MHz carrier (carrier #1)+20 MHz carrier (carrier #2)+20 MHz carrier (carrier #3)+5 MHz carrier (carrier #4).

FIG. 6 illustrates an example of a protocol structure for supporting multiple carriers. A common medium access control (MAC) entity 210 manages a physical (PHY) layer 220 which uses a plurality of carriers. A MAC management message transmitted by a particular carrier may be applied to other carriers. The PHY layer 220 may operate e.g. in a TDD (Time Division Duplex) and/or FDD (Frequency Division Duplex) scheme.

There are several physical control channels used in the physical layer 220. A physical downlink control channel (PDCCH) may inform the UE about the resource allocation of paging channel (PCH) and downlink shared channel (DL-SCH), and hybrid automatic repeat request (HARQ) information related to DL-SCH. The PDCCH may carry the uplink scheduling grant which informs the UE about resource allocation of uplink transmission. A physical control format indicator channel (PCFICH) informs the UE about the number of OFDM symbols used for the PDCCHs and is transmitted in every subframe. A physical Hybrid ARQ Indicator Channel (PHICH) carries HARQ ACK/NAK signals in response to uplink transmissions. A physical uplink control channel (PUCCH) carries uplink control data such as HARQ ACK/NAK in response to downlink transmission, scheduling request and channel quality indicator (CQI). A physical uplink shared channel (PUSCH) carries uplink shared channel (UL-SCH).

Each component carrier may have its own control channel, i.e. PDCCH. Alternatively, only some component carriers may have an associated PDCCH, while the other component carriers do not have their own PDCCH.

Component carriers may be divided into a primary component carrier (PCC) and one or several secondary component carriers (SCCs) depending on whether they are activated. A PCC may be constantly activated, and an SCC may be activated or de-activated according to particular conditions. Activation means that transmission or reception of traffic data is performed or traffic data is ready for its transmission or reception. Deactivation means that transmission or reception of traffic data is not permitted. In the deactivation, measurement is made or minimum information can be transmitted or received. The UE generally uses only a single PCC and possibly one or more SCCs along with the PCC.

A PCC is a component carrier used by a BS to exchange traffic and PHY/MAC control signaling (e.g. MAC control messages) with a UE. SCCs carriers are additional component carriers which the UE may use for traffic, only per BS's specific commands and rules received e.g. on the PCC. The PCC may be a fully configured carrier, by which major control data is exchanged between the BS and the UE. In particular, the PCC is configured with PDCCH. The SCC may be a fully configured component carrier or a partially configured component carrier, which is allocated according to a request of the UE or according to an instruction of the BS. The PCC may be used for entering of the UE into a network or for an allocation of the SCC. The primary carrier may be selected from among fully configured component carriers, rather than being fixed to a particular component carrier. A component carrier set as an SCC carrier may be changed to a PCC.

A PCC may further have at least some of the following characteristics:
to be in accordance with the definitions of the PCC introduced in Rel-10 CA;
uplink PCC and downlink PCC may be configured per UE;
uplink PCC may be used for transmission of L1 uplink control data;
downlink PCC cannot be de-activated;
re-establishment may be triggered when the downlink PCC experiences RLF (radio link failure), not when other downlink CC's experience RLF;
SI (system information) reception for the downlink PCC, Rel-8 procedures may apply;
this may not imply anything for the reception of the SI of other configured CC's;
NAS information may be taken from the downlink PCC cell.

The Rel-8 DRX procedures (when carrier aggregation is not implemented) define UE PDCCH monitoring requirements. Those requirements are defined in particular in the technical specification 3GPP TS 36.321 V8.8.0 (2009-12), 3rd Generation Partnership Project; Technical Specification Group Radio Access Network; Evolved Universal Terrestrial Radio Access (E-UTRA) Medium Access Control (MAC) protocol specification (Release 8).

In particular, 3GPP TS 36.321 V8.8.0 defines an Active Time, within a DRX cycle and related to DRX operation, as a time during which the UE monitors the PDCCH in PDCCH-subframes (see section 3.1).

The total duration of the Active Time is driven by several timers. Three main timers can be identified, namely: on-duration timer, an inactivity timer and a retransmission timer (or HARQ RTT timer). Other timers may be taken into account such as: longDRX-Cycle, drxStartOffset, drxShortCycleTimer and/or shortDRX-Cycle.

In LTE FDD (frequency division duplex) system, DL (downlink) and UL (uplink) carrier are always paired, i.e. there is a one-to-one association/linkage between the DL and UL carrier. In LTE-Advanced system with carrier aggregation, several component carriers are aggregated to provide higher peak data rate. The transmission on multiple CCs with symmetric or asymmetric DL/UL component carriers are both supported. In RANI discussion (see in particular R2-097377, LS on PDCCH monitoring set for carrier aggregation in LTE-Advanced and RANI_{—}57bis Chairman Notes), the related DL CC sets and the corresponding definitions have been defined.

The UE DL Component Carrier Set is defined as the set of DL component carriers configured by dedicated signalling on which a UE may be scheduled to receive the PDSCH (Physical Downlink Shared Channel) in the DL.

The PDCCH Monitoring Set is defined as a set of DL CCs on which the UE is required to monitor the PDCCH (Physical Downlink Control Channel). Its size is less than or equal to the size of the UE DL CC set and it comprises only CCs that are in the UE DL CC set.

### DISCLOSURE OF INVENTION

### Technical Problem

However, current definitions of DL CC sets and PDCCH monitoring set are incomplete since they do not specify how and which CC can be included within each set. For instance the question of how a CC on which UE does not monitor PDCCH, nor receive PDSCH should be handled is not addressed. Whether such CC should be known by the UE in order to perform mobility measurement remains an open question.

### Solution to Problem

To improve this situation, the invention proposes a method for managing aggregation of component carriers between an e Node B and a user equipment, wherein, a primary component carrier being a component carrier usable before carrier aggregation is configured, and a secondary component carrier being a component carrier usable only when carrier aggregation is configured, the method comprises:

/a/ reporting, by the user equipment, component carriers aggregation capabilities of the user equipment to the e Node B through a primary component carrier;

/b/ transmitting a measurement report from the user equipment to the e Node B, wherein the measurement report contains a list of reliable secondary component carriers;

/c/ configuring, in the user equipment, by the e Node B, a first set consisting of secondary component carriers which, based on the reports received in steps /a/ and /b/, are reliable and which the user equipment is able to manage;

/d/ activating, by the e Node B, at least one secondary component carrier from the first set, and providing, by the e Node B, a second set consisting of the primary component carriers and of all activated secondary component carriers;

wherein the component carriers of the second set are the only ones that can be used to communicate data between the e Node B and the user equipment, and wherein a secondary component carrier can be activated only if it belongs to the first set.

Such method is advantageous in that it enables a flexible carrier aggregation.

The invention also proposes a user equipment arranged to manage the aggregation of component carriers with an e Node B, wherein, a primary component carrier being a component carrier usable before carrier aggregation is configured, and a secondary component carrier being a component carrier usable only when carrier aggregation is configured, the user equipment comprises:
a transmitter for sending, to the e Node B, through a primary component carrier, a component carriers aggregation capabilities report and a measurement report, wherein the measurement report contains a list of reliable secondary component carriers;
a receiver for receiving a first set consisting of secondary component carriers which, based on the reports sent by the transmitter, the user equipment is able to manage;
a processor for activating at least one secondary component carrier from the first set, and for providing a second set consisting of the primary component carriers and of all activated secondary component carriers;

wherein the component carriers of the second set are the only ones that can be used to communicate data between the e Node B and the user equipment, and wherein only a component carrier of the first set can be activated.

Such user equipment is advantageous in that it enables a flexible management of carrier aggregation with an e Node B.

### Advantageous Effects of Invention

The following improvements are advantageous:

Improvement 1: Only reliable CCs, i.e. those included in a UE measurement report, can be configured, to be included in a DL Configured CC set.

Improvement 2: The UE maintains a set of configured CCs where newly configured CC can be added and existing CCs in the set can be removed or replaced by a newly configured CC.

Improvement 3: Only CC from the Configured CC set shall be activated (i.e. it should be impossible to activate a CC that is not in the configure CC set).

Improvement 4: The Active CC set shall always contain at least one CC (the primary component carrier).

Improvement 5: Only Secondary Component Carrier can be de-activated/activated.

Improvement 6: The Primary Component Carrier can indicate activation and/or PDCCH monitoring in Secondary Component Carriers.

Improvement 7: The DL cross carrier scheduling indicator (CIF) shall be restricted to activated DL CC.

### BRIEF DESCRIPTION OF DRAWINGS

Embodiments of the present invention are illustrated by way of example, and not by way of limitation, in the figures of the accompanying drawings, in which like reference numerals refer to similar elements and in which:

FIG. 1 is a diagram showing an exemplary radiocommunication system;

FIG. 2 is a diagram showing an exemplary overview of an E-UTRAN architecture;

FIG. 3 is a diagram showing an exemplary user-plane protocol stack for E-UTRAN;

FIG. 4 is a diagram showing an exemplary control-plane protocol stack for E-UTRAN;

FIG. 5 is a diagram schematically showing a PDCCH channel arrangement;

FIG. 6 is a diagram showing an exemplary protocol structure for supporting multiple carriers (carrier aggregation);

FIG. 7 illustrates reference models for asymmetric DL/UL carrier aggregation;

FIG. 8 is a diagram showing an exemplary and non-limiting wireless communication system according to an embodiment of the present invention.

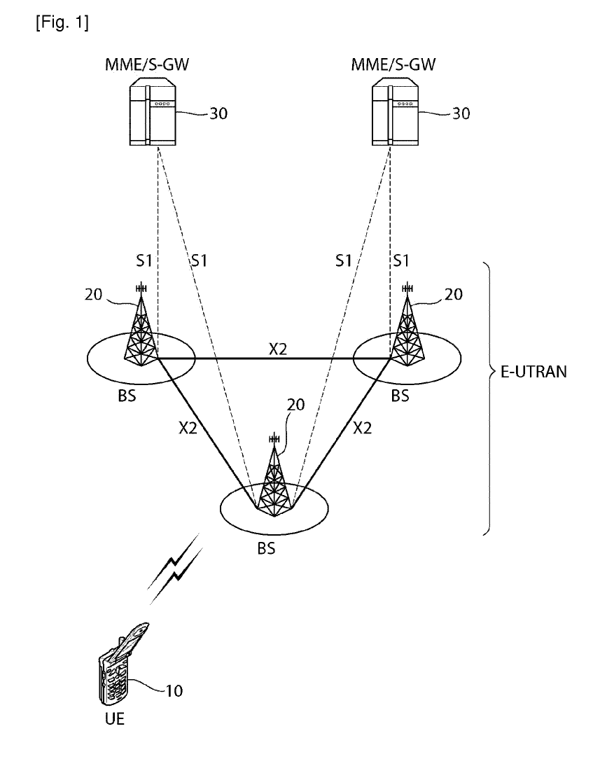

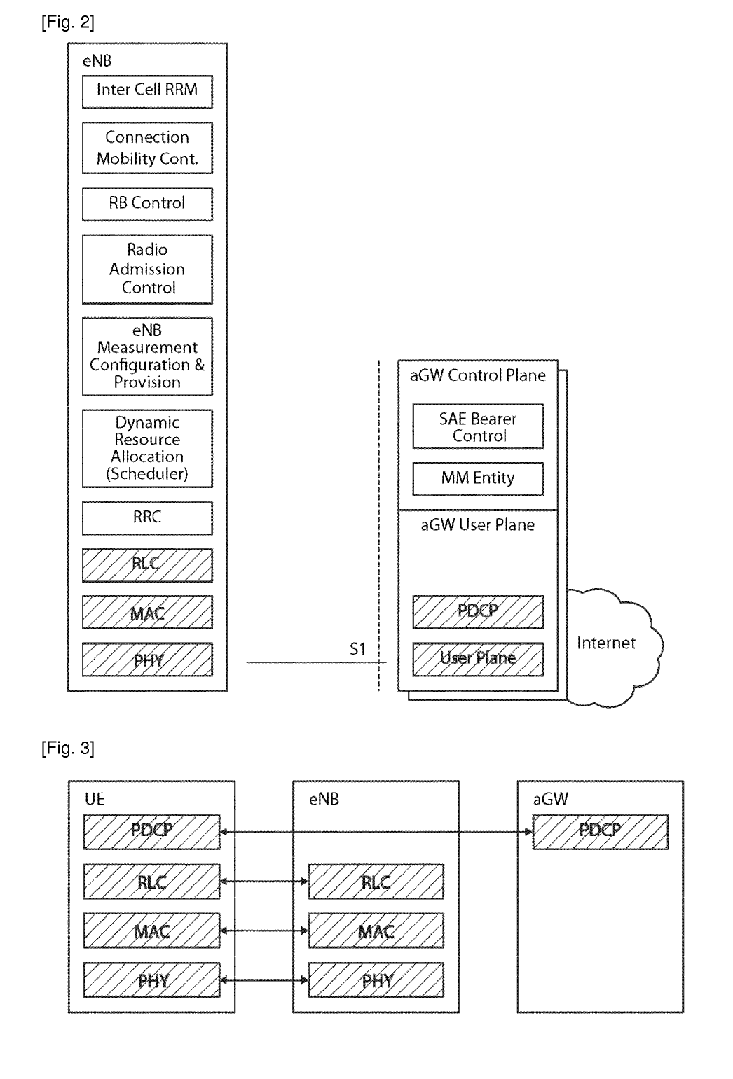

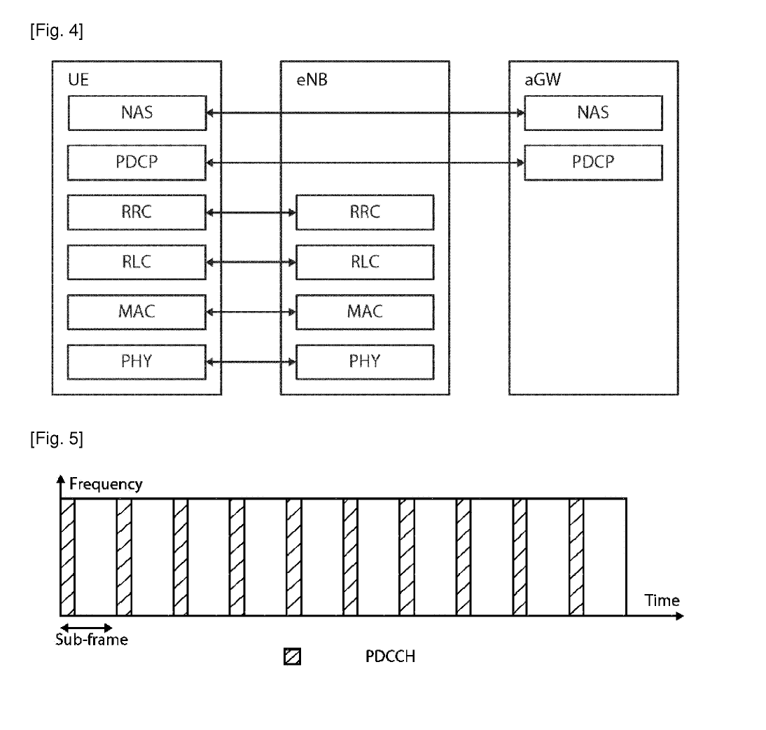

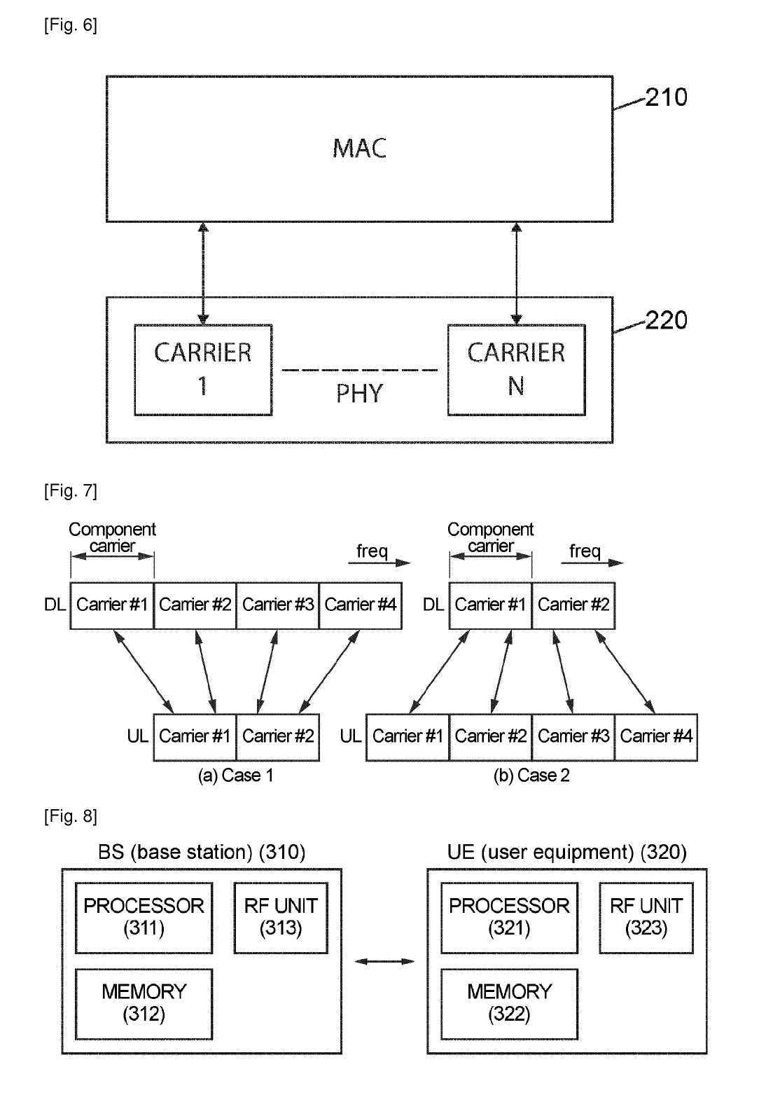

### BEST MODE FOR CARRYING OUT THE INVENTION

The invention will be described hereafter in the context of an LTE-A system supporting carrier aggregation as mentioned above. It applies however to any other type of system including at least one base station and at least one UE or equivalent, as will be apparent to one skilled in the art.

FIG. 8 shows an exemplary and non-limiting wireless communication system including a BS 310 and one or more UE(s) 320. In downlink, a transmitter may be a part of the BS 310, and a receiver may be a part of the UE 320. In uplink, a transmitter may be a part of the UE 320, and a receiver may be a part of the BS 310. The BS 310 may include a processor 311, a memory 312, and a radio frequency (RF) unit 313. The processor 311 may be configured to implement proposed procedures and/or methods described in the present document. In the exemplary system of FIG. 8, the memory 312 is coupled with the processor 311 and stores a variety of information to operate the processor 311. The RF unit 313 is coupled with the processor 311 and transmits and/or receives a radio signal.

The UE 320 may include a processor 321, a memory 322, and a RF unit 323. The processor 321 may be configured to implement proposed procedures and/or methods described in the present document. The memory 322 is coupled with the processor 321 and stores a variety of information to operate the processor 321. The RF unit 323 is coupled with the processor 321 and transmits and/or receives a radio signal.

The BS 310 and/or the UE 320 may have single antenna or multiple antennas. When at least one of the BS 310 and the UE 320 has multiple antennas, the wireless communication system may be called a multiple input multiple output (MIMO) system.

The BS 310 and the UE 320 support carrier aggregation, meaning that they may use multiple component carriers (CCs).

Among the multiple CCs, one or several CCs is/are configured with a Physical Downlink Control Channel, PDCCH, received by the UE 320 from the BS 310. The PDCCH configured on a given CC may be arranged for scheduling resources on a physical shared channel, e.g. a PDSCH or PUSCH, to the UE 320 on said given CC only. Alternatively, it may be arranged for scheduling resources on a physical shared channel, e.g. a PDSCH or PUSCH, to the UE 320 on at least one other CC among the multiple CCs (only or in addition to scheduling resources on a physical shared channel on said given CC).

According to a first embodiment, a method for managing aggregation of component carriers between an e Node B and a user equipment, wherein, a primary component carrier being a component carrier usable before carrier aggregation is configured, and a secondary component carrier being a component carrier usable only when carrier aggregation is configured, comprises:

/a/ reporting, by the user equipment, component carriers aggregation capabilities of the user equipment to the e Node B through a primary component carrier. For example, a user equipment consisting of a multi-band cellular phone could report, among other things, the frequencies corresponding to each of the bands that are supported, thereby enabling an e Node B to disregard potential CCs located in other bands than the supported ones.

/b/ transmitting a measurement report from the user equipment to the e Node B, wherein the measurement report contains a list of reliable secondary component carriers. The measures may be based, for example, on power measurement, such as RSRP and/or RSRQ.

/c/ configuring, in the user equipment, by the e Node B, a first set consisting of secondary component carriers (which are, in a possible implementation, initially de-activated) which, based on the reports received in steps /a/ and /b/, are reliable and which the user equipment is able to manage. Such configured CCs are interesting in that they constitute a pool from which CCs can be selected for subsequent activation. The configured CCs are not yet ready for being used for data communications.

/d/ activating, by the e Node B, at least one secondary component carrier from the first set, and providing, by the e Node B, a second set consisting of the primary component carriers (uplink and downlink) and of all activated secondary component carriers.

According to the method, the component carriers of the second set are the only ones that can be used to communicate data between the e Node B and the user equipment, and a secondary component carrier can be activated only if it belongs to the first set. This is advantageous as the second set defines the CCs that can be used for data communications.

According to a second embodiment, a method according to the first embodiment defines a first set comprising only deactivated secondary component carriers. Accordingly, the secondary CCs that are directly usable for data communications are not to be found in the first set but only in the second one.

According to a third embodiment, a method according to the first or second embodiments maintains the first and second sets in at least one of the user equipment and the e Node B. It is advantageous to maintain the first and second sets both in the user equipment and in the e Node B as this facilitates the management of carrier aggregation.

According to a fourth embodiment, a method according to any of the previous embodiments comprises deactivating an activated secondary component carrier responsive to at least one of an explicit deactivation request from the e Node B and a timer expiration in the user equipment. For example, it may be determined that an allocated secondary CC is not used while this CC could be very useful for neighboring UEs which may be in demand of higher bandwidth.

According to a fifth embodiment, a method according to any of the previous embodiments is arranged so that only secondary component carriers can be activated and deactivated. In particular, primary CCs cannot be activated or deactivated.

According to a sixth embodiment, a method according to any of the previous embodiments comprises indicating, in a primary component carrier, at least one of activation and control channels monitoring of activated secondary component carriers.

According to a seventh embodiment, a method according to any of the previous embodiments involves a primary component carrier comprising a cross carrier scheduling indicator (which can be a downlink cross carrier scheduling indicator) which is restricted to activated secondary component carriers. It is restricted in the sense that it cannot schedule data transmission in CCs other than activated secondary CCs.

According to a eighth embodiment, a method according to any of the previous embodiments is arranged so that step /a/ comprises reporting the number of downlink and uplink component carriers that the user equipment is able to aggregate. This is advantageous, considering that a user equipment, despite supporting multiple bands, might be restricted to aggregating a number of carriers lower than the number of bands it supports.

According to an ninth embodiment, a method according to any of the previous embodiments is arranged so that step /b/ comprises scanning the frequency spectrum by the user equipment in order to identify component carriers and reporting to the e Node B the component carriers that have been identified.

According to a tenth embodiment, a method according to any of the previous embodiments is arranged so that step /b/ comprises ranking identified component carriers according to measurement criteria. According to a possible embodiment, the tenth embodiment comprises reporting the ranking of the identified component carriers to the e Node B (for example in the form of an index). According to a possible embodiment, the tenth embodiment comprises sorting the identified component carriers according to their ranking and reporting the sorted component carriers to the e Node B. The fact that the CCs are sorted means that their ranking does not have to be explicitly transmitted (it can be inferred from the order in which the CCs are received).

According to an eleventh embodiment, a method according to any of the previous embodiments is arranged so that step /c/ comprises using dedicated signaling (such as RRC, which is a control channel in CC) to configure the first set of component carriers in the user equipment. RRC is a layer 3 signaling between UE & UTRAN, performing functions for connection establishment and release, broadcast of system information, Radio Bearer establishment/reconfiguration and releases, RRC Connection mobility procedures, paging notification and release, outer loop power control, etc.

According to a twelfth embodiment, a method according to any of the previous embodiments is arranged so that step /d/ comprises using dedicated signaling (such as MAC CE, i.e. a control element for activation/deactivation) to activate the second set of component carriers in the user equipment.

According to a thirteenth embodiment, a method according to any of the previous embodiments is arranged so that the user equipment regularly carries out measurement reports for all component carriers and transmits the reports to the e Node B and wherein, based on the measurements reports, the e Node B:
removes existing secondary component carriers from the first set when they are no longer reliable enough and
configures new secondary component carriers in the first set when they become reliable enough.

Accordingly, the first set is advantageously continuously up to date, and the second set can be updated accordingly.

According to a fourteenth embodiment, an e Node B arranged to manage the aggregation of component carriers with a user equipment, wherein, a primary component carrier being a component carrier usable before carrier aggregation is configured, and a secondary component carrier being a component carrier usable only when carrier aggregation is configured, comprises:
a receiver for obtaining, from the user equipment, through a primary component carrier, a component carriers aggregation capabilities report and a measurement report, wherein the measurement report contains a list of reliable secondary component carriers. The e Node B also comprises logic (such as hardwire logic or software) for specifically obtaining the above information (as opposed to generically obtaining any kind of information). Such logic may for example consist of a high layer relying on a lower layer that is typically embedded in any receiver (for the purpose of receiving any kind of data). Such logic may recognize that received data correspond to the above data (capabilities report, measurement reports . . . ) whether such data have been previously requested or have been communicated without request. Recognized data can then be handled accordingly (for example they can be stored in a specific memory, and/or can trigger the execution of a specific routine).
a processor configured for providing a first set consisting of secondary component carriers which, based on the reports received by the receiver, the user equipment is able to manage, for activating at least one secondary component carrier from the first set, and for providing a second set consisting of the primary component carriers and of all activated secondary component carriers. Accordingly, the e Node B stores appropriate software executable by the processor in order for the processor to behave in the so configured way.

In this e Node B, the component carriers of the second set are the only ones that can be used to communicate data between the e Node B and the user equipment, and wherein only a component carrier of the first set can be activated.

According to a fifteenth embodiment, a user equipment arranged to manage the aggregation of component carriers with an e Node B, wherein, a primary component carrier being a component carrier usable before carrier aggregation is configured, and a secondary component carrier being a component carrier usable only when carrier aggregation is configured, comprises:
a transmitter for sending, to the e Node B, through a primary component carrier, a component carriers aggregation capabilities report and a measurement report, wherein the measurement report contains a list of reliable secondary component carriers. The user equipment also comprises logic (such as hardwire logic or software) for specifically sending the above information (as opposed to generically sending any kind of information). Such logic may for example consist of a high layer relying on a lower layer that is typically embedded in any transmitter (for the purpose of transmitting any kind of data). Such logic may for example build the data to be sent (based on the measurement report, capabilities report, . . . ) by putting it in a proper data structure and/or encapsulate it in packets adapted to a protocol of the transmitter.
a receiver for receiving a first set consisting of secondary component carriers which, based on the reports sent by the transmitter, the user equipment is able to manage. The user equipment also comprises logic (such as hardwire logic or software) for specifically obtaining the first set (as opposed to generically obtaining any kind of information). Such logic may for example consist of a high layer relying on a lower layer that is typically embedded in any receiver (for the purpose of receiving any kind of data). Such logic may recognize that received data correspond to the above data (first set) whether such data have been previously requested or have been communicated without request. Recognized data can then be handled accordingly (for example they can be stored in a specific memory, and/or can trigger the execution of a specific routine).
a processor for activating at least one secondary component carrier from the first set, and for providing a second set consisting of the primary component carriers and of all activated secondary component carriers. Accordingly, the user equipment stores appropriate software executable by the processor in order for the processor to behave in the aforementioned way by activating and providing the relevant pieces of information.

In this user equipment, the component carriers of the second set are the only ones that can be used to communicate data between the e Node B and the user equipment, and wherein only a component carrier of the first set can be activated.

FIG. 7 show two simple examples of the asymmetric DL/UL carrier aggregation. In case 1 (example (a)), one UL CC is linked to multiple DL CCs, while in case 2 (example (b)) one DL CC is linked to multiple UL CCs. Case 1 is a baseline assumption for LTE-A, i.e. case 1 is the expected situation since in a typical LTE-A scenario, downlink requirements are higher (in terms of bandwidth) than uplink requirements, and accordingly one can expect to require more DL CCs than UL CCs (assuming that each CC offers the same bandwidth, which is not necessarily true).

According to a possible embodiment detailed below, it can be assumed that the DL CC on which a UE is initially synchronized and receives system information will become automatically an active CC. On the active CC the UE should monitor PDCCH and/or receive PDSCH and/or perform required measurement such (e.g. CQI, a.k.a Channel Quality Indicator). Additional CC can be activated provided that they are reliable from the UE point of view. The reliable CCs (or set of reliable CCs) are reported via measurement report by the UE to the e Node B. They are ordered by priority with the strongest RSRP/RSRQ (Reference Signal Received Power/Reference Signal Received Quality). According the measurement report the e Node B can configure, by dedicated RRC signaling, all or part of the CCs to a specific UE. Once a CC is configured, the e Node B can activate it, either explicitly or implicitly, in order to allow the UE to monitor PDCCH and PDSCH.

According to a possible embodiment, two sets of DL CCs need to be maintained by UE and/or eNB, namely a DL Configured CC set and a DL Active CC set.

As far as the first set is concerned, based on the UE measurement report, the CCs to be included in the DL Configured CC set are configured by e Node B in the UE (the e Node B can maintain a list of configured CC in parallel with building such list in the UE, and preferably keeps the two sets synchronized) with dedicated signaling (RRC). Measured CCs can be either detected by the UE itself or can be indicated by the e Node B. The e Node B configures each CC separately or set of CCs. In order to save UE power consumption it is beneficial that UE does not monitor PDCCH, nor receive PDSCH and minimize the number of required measurement within this set. Therefore UE should perform at least RSRP/RSRQ measurement to ensure reliability in case of mobility. If necessary, additional measurements, with low battery consumption and low reporting overhead, for appropriate resource allocation (e.g. adapt the Modulation Coding Scheme MCS to the UE channel quality) can be considered in case it is important for the e Node B to have adequate information on UE received DL channel quality. Otherwise, a conservative resource allocation can be used.

As far as the second set (DL Active CC set) is concerned, in order to be able to monitor the PDCCH and PDSCH, the UE would need to be already configured for the active component carriers. When component carrier is activated the UE shall be able to perform additional channel quality measurement (e.g. CQI) on each active component carrier. If active CCs are contiguous (belong to the same frequency band) then PDCCH transmission can be assumed to be time synchronized for all CC. In case the CCs are non-contiguous then asynchronous PDCCH transmission may be assumed. Therefore in order to cover both asynchronous and synchronous PDCCH transmission/Reception the notion of Primary CC or Primary PDCCH and Secondary CC or Secondary PDCCH would be advantageous. According to this embodiment, there is always at least one active component carrier, called Primary Component carrier. Therefore the Primary Component Carrier is never deactivated; only Secondary Component Carriers should be deactivated. In order to avoid system signaling overhead that requires higher layer reconfiguration to vary the set of active CCs especially for PDCCH monitoring the Primary Component Carrier can be used to indicate the PDDCH and/or PDSCH monitoring on other component carriers (Secondary Component Carriers). As it was agreed to introduce cross-carrier scheduling in LTE-A, the Carrier Indicator Field is a pointer to indicate the scheduling grants at other component carriers. It allows the allocation of traffic channels in the CCs that may be different from the CC on which PDCCH is transmitted, giving flexibility in carrier selection for PDCCH transmission. This feature is particularly useful for asymmetric multi-carrier systems. The CIF for cross-carrier scheduling enables the design of PDCCH-less component carriers to minimize the PDCCH overhead. The presence of cross carrier scheduling is semi-statistically configured, while the activation and deactivation of CC assumed to be dynamic. Thus in theory there could be situations where deactivated (configured) CC could be cross scheduled. However as it is assumed that on a non-active DL CC (i.e: configured DL CC), the UE does not receive PDCCH nor PDSCH, then the DL cross carrier scheduling must be restricted to activated DL CC.

Other embodiments may be envisaged within the framework of the present invention, as will be apparent to one skilled in the art.

### INDUSTRIAL APPLICABILITY

According to a possible embodiment, it is proposed to specify two DL CC sets as follows:
DL Configured CC set containing deactivated Secondary Component Carriers
DL Active CC set containing Primary Component Carrier and activated Secondary Component Carriers.

1. A method for managing aggregation of component carriers between an e Node B and a user equipment, wherein, a primary component carrier being a component carrier usable before carrier aggregation is configured, and a secondary component carrier being a component carrier usable only when carrier aggregation is configured, the method comprises:
/a/ reporting, by the user equipment, component carriers aggregation capabilities of the user equipment to the e Node B through a primary component carrier;
/b/ transmitting a measurement report from the user equipment to the e Node B, wherein the measurement report contains a list of reliable secondary component carriers;
/c/ configuring, in the user equipment, by the e Node B, a first set consisting of secondary component carriers which, based on the reports received in steps /a/ and /b/, are reliable and which the user equipment is able to manage;
/d/ activating, by the e Node B, at least one secondary component carrier from the first set, and providing, by the e Node B, a second set consisting of the primary component carriers and of all activated secondary component carriers;
wherein the component carriers of the second set are the only ones that can be used to communicate data between the e Node B and the user equipment, and wherein a secondary component carrier can be activated only if it belongs to the first set.

2. The method according to claim 1, wherein the first set comprises only deactivated secondary component carriers.

3. The method according to claim 1, wherein the first and second sets are maintained in at least one of the user equipment and the e Node B.

4. The method according to claim 1, comprising deactivating an activated secondary component carrier responsive to at least one of an explicit deactivation request from the e Node B and a timer expiration in the user equipment.

5. The method according to claim 4, wherein only secondary component carriers can be activated and deactivated.

6. The method according to claim 1, wherein a primary component carrier indicates at least one of activation and control channels monitoring of activated secondary component carriers.

7. The method according to claim 1, wherein a primary component carrier comprises a cross carrier scheduling indicator which is restricted to activated secondary component carriers.

8. The method according to claim 1, wherein step /a/ comprises reporting the number of downlink and uplink component carriers that the user equipment is able to aggregate.

9. The method according to claim 1, wherein step /b/ comprises scanning the frequency spectrum by the user equipment in order to identify component carriers and reporting to the e Node B the component carriers that have been identified.

10. The method according to claim 9, wherein step /b/ comprises ranking identified component carriers according to measurement criteria.

11. The method according to claim 1, wherein step /c/ comprises using dedicated signaling to configure the first set of component carriers in the user equipment.

12. The method according to claim 1, wherein step /d/ comprises using dedicated signaling to activate the second set of component carriers in the user equipment.

13. The method according to claim 1, wherein the user equipment regularly carries out measurement reports for all component carriers and transmits the reports to the e Node B and wherein, based on the measurements reports, the e Node B:
removes existing secondary component carriers from the first set when they are no longer reliable enough and
configures new secondary component carriers in the first set when they become reliable enough.

14. An e Node B arranged to manage the aggregation of component carriers with a user equipment, wherein, a primary component carrier being a component carrier usable before carrier aggregation is configured, and a secondary component carrier being a component carrier usable only when carrier aggregation is configured, the e Node B comprises:
a receiver for obtaining, from the user equipment, through a primary component carrier, a component carriers aggregation capabilities report and a measurement report, wherein the measurement report contains a list of reliable secondary component carriers;
a processor configured for providing a first set consisting of secondary component carriers which, based on the reports received by the receiver, the user equipment is able to manage, for activating at least one secondary component carrier from the first set, and for providing a second set consisting of the primary component carriers and of all activated secondary component carriers;
wherein the component carriers of the second set are the only ones that can be used to communicate data between the e Node B and the user equipment, and wherein only a component carrier of the first set can be activated.

15. A user equipment arranged to manage the aggregation of component carriers with an e Node B, wherein, a primary component carrier being a component carrier usable before carrier aggregation is configured, and a secondary component carrier being a component carrier usable only when carrier aggregation is configured, the user equipment comprises:
a transmitter for sending, to the e Node B, through a primary component carrier, a component carriers aggregation capabilities report and a measurement report, wherein the measurement report contains a list of reliable secondary component carriers;
a receiver for receiving a first set consisting of secondary component carriers which, based on the reports sent by the transmitter, the user equipment is able to manage;
a processor for activating at least one secondary component carrier from the first set, and for providing a second set consisting of the primary component carriers and of all activated secondary component carriers;
wherein the component carriers of the second set are the only ones that can be used to communicate data between the e Node B and the user equipment, and wherein only a component carrier of the first set can be activated.
